(19) United States
(12) Patent Application Publication
(10) Pub. No.: US 2024/0343922 A1
(43) Pub. Date: Oct. 17, 2024

(54) AEROGEL PAINT WITH FIREPROOF AND HEAT INSULATION PROPERTIES AND PREPARATION METHOD THEREOF

(71) Applicant: Taiwan Aerogel Technology Material Co, Ltd., Tainan (TW)

(72) Inventors: JEAN-HONG CHEN, Tainan (TW); CHENG-SHU CHIANG, Tainan (TW); YA-CHI KO, Tainan (TW); CHI-HUNG LO, Tainan (TW); WEN-YEN HSU, Tainan (TW)

(21) Appl. No.: 18/405,036

(22) Filed: Jan. 5, 2024

(30) Foreign Application Priority Data
Apr. 11, 2023 (TW) 112113542
Apr. 12, 2023 (TW) 112203358

(51) Int. Cl. C09D 5/18; C01B 33/145; C01B 33/155; C01B 33/158; C09D 5/02; C09D 7/45; C09D 7/61; C09D 7/80; H01M 10/658; H01M 50/383

(52) U.S. Cl. CPC C09D 5/18; C01B 33/145; C01B 33/155; C01B 33/1585; C09D 5/021; C09D 7/45; C09D 7/61; C09D 7/80; H01M 10/658; H01M 50/383; C01P 2004/03; C01P 2006/10; C01P 2006/16; C01P 2006/32

(57) ABSTRACT

The present invention discloses an aerogel paint with smoke-free, fireproof and high heat insulation properties and preparation method thereof. The method comprises steps of: (1) mixed hydrolysis, (2) condensation and dispersion, (3) atmospheric drying, (4) high-temperature-resistant glue mixing, (5) homogenizing and dispersing. In this technology, the aerogel particles can be prepared by condensation under suspension and dispersion, and the aerogel particles have more uniform particle sizes. After being dried with hot air on an atmospheric condition, the aerogel paint is then prepared by mixing a high-temperature-resistant glue solution with the dried aerogel particles to obtain an aerogel paint being smoke-free, toxic-free, highly fire-proof and highly heat insulative. The products developed in the present invention withstand impact of high-temperature flames more than 1200° C. for a long time, and remain unpenetrated of the aluminum plate. The product is therefore suitable for safety protection of electric vehicles from lithium battery modules thermal runaway.

### CROSS REFERENCE TO RELATED APPLICATION

This application claims the benefit of Taiwan patent application Serial. No. 112113542, filed Apr. 11, 2023, and Taiwan patent application Serial. No. 112203358, filed on Apr. 12, 2023 and issued as Taiwan. Patent No. M644188 on Jul. 21, 2023.

### FIELD OF THE INVENTION

The present invention is related to an aerogel paint having fire-proof and heat insulation properties, and especially related to an aerogel composite paint being smoke-free, high thermal insulative and high fire-proof and a method for making thereof.

### BACKGROUND OF THE INVENTION

It has been well acknowledged that aerogel is a porous material with a three-dimensional network structure, and having characteristics such as high porosity (higher than 80% or even higher than 95%), low density (about 0.05 to 0.2 g/cm³), high specific surface area (500 to 2000 m²/g), low thermal conductivity (k=15 to 40 mW/mk), low dielectric properties (Dₖ=1.3 to 2.0), and low dielectric loss (D_{f}<0.003 or less). Intrinsic physical properties of aerogel make it or its composite materials have excellent properties such as high thermal insulation, high fire resistance, high specific surface area and extremely low density, and low dielectric properties, rendering aerogel to be considerably valuable in applications such as high thermal insulation, high fire resistance, low signal transmission resistance, and high resistance to electrical shock. Therefore, aerogel occupies strategical position as being be used to energy-saving and carbon-reduction applications in various industries such as high temperature fire protection, high energy consumption production equipment or transmission pipelines.

Although the current organic foaming materials have good thermal insulation effects at room temperature or below 120° C., these organic foaming materials would rapidly decompose and lose their thermal insulation effect in an environment at temperature higher than 120° C., which limits their application.

In addition, the current high-temperature fireproof and heat-insulating paints are mainly thermal expansion organic paints. The above products are generally made by mixing organic paints such as epoxy, polyurethane, or polyacrylate, with thermally expandable metal oxides, and taking advantage of the thermal expansion characteristics of metal oxide or carbon to achieve fire-proof and heat insulative effects under high-temperature flames. However, when the above products are used in high-temperature applications, organic paints such as epoxy resin would carbonize and decompose into toxic substances such as dioxin under high-temperature flames above 500° C. Moreover, the thermally-expanded metal oxide layer would also crack and fall off under high-temperature flames, resulting in loss of protection. Therefore, in the future, the thermal runaway protection of lithium battery modules in electric automobiles relies on development of better fire-proof paint to replace the traditional thermal-expandable metal oxide organic fire-proof paint.

Aerogel is a material with a nano-porous inorganic silica three-dimensional network structure. Aerogel or its related composite materials can replace traditional organic foaming materials, thermally expandable metal oxides or thermally expandable carbon added organic fire-proof paints, to be a novel fire protection and thermal insulation product.

Based on basic material theory, with large amounts of nano-porosity inside the aerogel material, thermal energy transmission would be significantly reduced. Hence, the higher the porosity of the material structure, the better its thermal insulation properties. In this regard, the applicant anticipates to meet safety demand of lithium battery module in electric automobiles or new generation high-temperature molten batteries by developing a smoke-free and non-toxic aerogel having fire-proof and thermal insulating properties. The present invention aims to provide effective solutions for thermal runaway of lithium battery modules in electric automobiles or for the safety of the new generation high-temperature molten batteries, both of which are currently urgent goals.

At present, various patented technologies of thermal insulation paints or high-temperature fire-proof paints disclosed by international published patents still have the above concerns. Especially at temperatures above 600°, the currently disclosed technologies use aerogels added with organic coatings (such as: epoxy resin, polyamide ester, polyacrylate, etc.). The maximum heat resistance temperature of these products is about 200° C. If heated in a high temperature environment for a long time, the organic coatings would crack and produce toxic gases. For the above fire prevention and heat insulation The shortcomings of fire-proof and thermal insulative paints remain important issues to be addressed in application of protection against thermal runaway of lithium battery modules in electric automobiles.

Disclosed in Chinese Pat. No. CN106479297A is “aerogel-containing water-based expansion type fire-retardant coating and a preparation method thereof”, wherein the aerogel-containing water-based expansion type fire-retardant coating comprises, by weight, 10-50 parts of emulsion, 30-70 parts of expansion type fire retardant, 0.1-10 parts of first neutralizer, 1-10 parts of plasticizer, 2-20 parts of fusing assistant, 0.1-10 parts of first dispersant, 0.1-10 parts of first stabilizer, 5-10 parts of aerogel pulp and 5-60 parts of pigments and fillers, wherein the emulsion is a mixture of core-shell type organosilicon-modified acrylate emulsion and pure acrylic emulsion. The organsilicon-modified acrylate emulsion and the pure acrylic emulsion are selected as an emulsion system, the organsilicon-modified acrylate emulsion has excellent physical and chemical properties of weather fastness and stain resistance, good breathability and high hydrophobicity and the like, good expansion effect and fire retardant property are achieved, mechanical properties in adhesive force of the fire-retardant coating can be improved by the aid of the pure acrylic emulsion, fire retardant property of the carbonized coating is assuredly and effectively exerted, and the fire-retardant coating is good in fire retardant property, stable in performance and easy to produce, wherein the core-shell silicone-modified acrylate emulsion is prepared by silicon-acrylic emulsion polymerization of a mixture of vinyltriethoxysilane and styrene and a mixture of butyl acrylate and methyl methacrylate.

Disclosed in Chinese Pat. No. CN107267006A is “aerogel-containing waterborne thermal-insulation and fireproof coating and a preparation method thereof”, wherein the coating is mainly prepared from aerogel powder, waterborne resin and a flame retardant, wherein the aerogel powder contains an internal hydrophobic layer and a surface hydrophilic layer, and the surface hydrophilic layer is 0.1-100 m thick. The preparation method of the aerogel-containing waterborne thermal-insulation and fireproof coating comprises the following steps: (1) modifying the aerogel powder; (2) mixing the aerogel powder obtained in the step (1) with the waterborne resin and the flame retardant, and performing stirring or ball milling. The aerogel powder is added to a waterborne coating system so that the nano-porous structure of aerogel is prevented from being damaged, and thermal-insulation performance of the aerogel is fully exerted, and fire endurance of the coating is improved. This invention adds aerogel powder to the water-based coating system to ensure that the nanoporous structure of the aerogel is not destroyed, fully utilizes the heat insulation performance of the aerogel, and improves the fire resistance limit of the coating. It is characterized that it is mainly composed of aerogel powder, water-based resin and flame retardant. The aerogel powder is composed of an internal hydrophobic layer and a surface hydrophilic layer. The thickness of the surface hydrophilic layer is 0.1-100 m.

Disclosed in Chinese Pat. No. CN108587264A is “invisible aerogel fireproof coating” involving silica aerogel hydrophobicity enhancement modification and coating preparation phases, wherein the materials used in the silica aerogel hydrophobicity enhancement modification phase include water glass, carbon nano fiber, anhydrous ethyl alcohol, acetone, n-butyl alcohol, cetyl trimethyl ammonium bromide, trimethylchlorosilane, styrene exchange resin, liquid ammonia, and kerosene. The materials used in the coating preparation phase include the modified hydrophobicity-enhanced silica aerogel, sodium sulfite, talcum powder, sodium chloride, a carbonizing catalyst, a carbonizing agent, a foaming agent, and an antiaging agent. Pentaerythritol is added as a carbonizing agent to the coating to expand the carbon source in the carbon layer to enhance the insulative function of the aerogel.

Although the aforementioned existing technologies are all related to the manufacturing technology of aerogel organic heat-insulating paints or thermal expansion organic paints, these technologies all depend on the thermal expansion of inorganic substances at high temperatures from several times to dozens of times, and depending on the thermally-expanded air for thermal insulation. Currently, the gap between the lithium battery modules in electric automobiles is extremely narrow, so using the above thermal expansion products would undermine lithium battery modules' safety caused by high pressure under the condition of thermal runaway.

The existing technologies generally use aerogel or aerogel mixing inorganic powder and organic coatings, such as epoxy resin, water-based polyamide ester coating (commonly known as water-based PU coating), water-based polyacrylate coating (commonly known as water-based acrylic coating), etc., a drawback of water-based coatings is that the highest heat-resistant temperature is mostly below 200° C. Therefore, the existing technologies use flame retardants to increase the heat-resistant temperature. When the environment is above 200° C., the organic coating would rapidly age and crack, resulting that aerogel insulation paints fall off and produce toxic fumes.

In view of shortcomings of the aforementioned aerogels added with organic glue material due to high-temperature pyrolysis of organic glue materials, the applicant came up with the idea of improvement, and conducted in-depth improvement research. After a long period of hard work, the present invention was finally produced. The main purpose of the present invention is to provide a silicon-based aerogel paint having fireproof and heat-insulating properties and a preparation method thereof, wherein the silicon-based aerogel paint is smoke-free, non-toxic, high fire-proof and high heat-insulative under high-temperature flames.

### SUMMARY OF THE INVENTION

Therefore, in order to improve shortcomings of the current thermal insulation paint or fire-proof paint using epoxy resin, water-based polyamide ester coating, water-based polymethyl methacrylate coating mixed with aerogel or thermally expandable metal oxide. For example, in long-term exposure to sunlight or in the high-temperature environments above 300° C., organic coatings are prone to age and decompose and cause aerogel dust to fall off. For another example, exposure to flames above 500° C. that is produced by thermal runaway lithium battery modules results in rapid burning of the aforementioned organic coatings.

The primary object of the present invention is to provide a preparation method for making an aerogel fire-proof paint formed by combining aerogel with high-temperature-resistant inorganic glues, and the aerogel fire-proof and heat-insulating paint is smoke-free, non-toxic, highly fire-resistant, and highly resistant to high-temperature flames. Silicone-based aerogel fire-proof and heat-insulating paint having thermal insulation properties can be used in high-temperature manufacturing processes in clean rooms and in the safety protection of thermal runaway of lithium battery modules for electric automobiles.

Another object of the present invention is to provide a preparation method for making an aerogel fire-proof and heat-insulating paint, wherein the aerogel fire-proof and heat-insulating paint has excellent adherent strength to the surface of metallic material. In long-term exposure to sunlight, the aerogel fire-proof and heat-insulating paint does not age and decompose, and suitable for application in automobiles or electric automobiles that needs to be placed outdoor for a long time.

Yet another object of the present invention is to provide a method for making an aerogel fire-proof and heat-insulating paint, wherein the aerogel fire-proof and heat-insulating paint is combined with highly fire-proof paint and highly thermal insulating aerogel particles. The aerogel fire-proof and heat-insulating paint is especially suitable for application in thermal runaway or insulation of heat dissipation of lithium battery modules in electric automobiles. The aerogel fire-proof and heat-insulating paint is painted on outer shell of the electric automobile battery module or electric automobile chassis so as to prevent rapid heat conduction from the electric automobile chassis to driver's cabinet due to thermal runaway of the electric automobile battery module and increase safety of personnels in the electric automobile.

The method provided in the present invention can be performed to prepare an aerogel fire-proof and heat-insulating paint having excellent adherent strength to metallic plate surface, and being smoke-free, non-toxic, highly fire-proof, highly thermal insulative. The aerogel fire-proof and heat-insulating paint is especially related to applications in protection against thermal runaway of lithium battery modules in electric automobile, metallic panel of fireproof door, H beam, or internal fireproof and thermal insulation of high-speed military aerospace vehicles. The method comprises steps of:
a mixed hydrolysis step (S1): adding siloxane precursors to an ethanol water solution so as to form a mixed solution, and adding an acid catalyst to the mixed solution so that the siloxane precursors are hydrolyzed into a hydrolyzed siloxane compound mixture, wherein the siloxane precursors comprise hydrophobic-modified siloxane compounds, siloxane compounds or a combination thereof, and wherein the hydrophobic-modified siloxane compounds comprise alkyl groups of variable chain lengths;
a condensation and dispersion step (S2): adding a alkali catalyst solution to the mixed solution to perform a condensation reaction so as to obtain a condensation solution, and adding a large amount of dispersing water solution to the condensation solution, and then rapidly dispersing the condensation solution and the dispersing water solution by using an emulsifier or a homogenizer so that the suspended and dispersed sub-micron condensation solution system is gelled under continuous stirring to form an surface-stable aerogel wet-gel particle, and the aerogel wet-gel particle are suspended and dispersed in a large amount of dispersing water solution;
an atmospheric drying step (S3): filtering the dispersing water solution suspending the surface-stable aerogel wet-gel particle by using a filtration machine, and the surface-stable aerogel wet-gel particle is filtered; then providing an air flow having a drying temperature at atmospheric pressure in a drying tank to rapidly evaporate the remaining dispersing water solution from the surface-stable aerogel wet-gel particle so as to obtain a dried aerogel particle; because the surface-stable aerogel wet-gel particle contains a large amount of hydrophobic structure comprising alkyl groups of variable chain lengths, shrinkage and cracking of aerogel structure lead by water interfacial tension in the aerogel wet-gel particle can be suppressed during drying process; thus, combining the aforementioned technologies, the dried aerogel particle with porous structure, low heat conduction and high fire resistance can be quickly obtained;
a high-temperature-resistant glue mixing step (S4): preparing a high-temperature-resistant glue solution able to resist a high temperature of at least 500° C., and adding the dried aerogel particle to the high-temperature-resistant glue solution; and dispersing and impregnating the dried aerogel particle in the high-temperature-resistant glue solution by gentle stirring, and
a homogenizing and dispersing step (S5): homogenizing the high-temperature-resistant glue solution impregnating the dried aerogel particle by using a stirring machine to completely and homogeneously disperse the dried aerogel particle in the high-temperature-resistant glue solution so as to form an aerogel fire-proof and heat-insulating paint in a homogeneous status; through the aforementioned steps, the silicone-based aerogel fire-proof and heat-insulating paint presents paroperties including being smoke-free, non-toxic, highly fire-proof and high thermal insulative.

Preferably, in the mixed hydrolysis step (S1), the siloxane compounds comprise tetramethoxysilane (TMOS), tetraethoxysilane (TEOS) or a combination thereof; the hydrophobic-modified siloxane compounds comprise methyltrimethoxysilane (MTMS), propyltrimethoxysilane (PTMS), hexyltrimethoxysilane (HTMS), octyltrimethoxysilane (OTMS), hexamethyldisilazane (HMDS) or any combination thereof, and wherein in the siloxane precursors, a molar ratio of the siloxane compound to the hydrophobic-modified siloxane compound ranges from 0:100 mol % to 95:5 mol %; the purpose of adding the hydrophobic-modified siloxane compounds comprising alkyl groups of variable chain lengths is to minimize shrinkage and cracking of the aerogel structure during drying process, and lowering thermal conductive property thereof; on the other hand, adding the siloxane compounds is to regulate internal microstructure and increase the amount of porous structure as well as porosity of the aerogel structure so that thermal conductivity can be reduced or fire resistance can be enhanced.

Preferably, in the mixed hydrolysis step (S1), when content ratio of the acid catalyst in the mixed solution is higher, the hydrolysis rate is faster; however, in an electric field, large amount of acidic ions would produce ionic electric conductivity, which increase dielectric constant and lower dielectric strength of the aerogel structure; in contrast, when content ratio of acid catalyst is lower, the hydrolysis rate is slower, and dielectric constant of the aerogel structure would be significantly reduced, which increase electric resistance and dielectric strength.

Therefore, by reducing the acid catalyst content and increasing the process temperature to accelerate the hydrolysis of trace acid ions, the present invention can significantly reduce the content of acid ions and condensed base ions in the overall system; on the other hand, the silicone compound and hydrophobic-modified siloxane compounds would produce a large amount of alcohol molecules during the hydrolysis process. Hence, deionized water is used to replace organic solvents such as ammonia and alkanes during the hydrolysis process, thereby reducing ammonia, alkanes and other organic solvents; in addition to reducing the impact of organic solvents such as ammonia on the dielectric properties of aerogels, the hazards and environmental pollution of organic solvent treatment during the production process can be reduced, and the overall aerogel production cost can also be minimized.

Preferably, in the mixed hydrolysis step (S1), in the entire mixed solution, the higher the content of the alcohol water solution, the higher the internal porosity of the dried aerogel particle subsequently; in contrast, in the entire mixed solution, the lower the content of the alcohol water solution, the lower the internal porosity of the dried aerogel particle subsequently; wherein, the alcohol water solution comprises ethanol, recycled ethanol water solution, recycled methanol solution, recycled water, deionized water, filtered water, distilled water or any combination thereof.

Preferably, in the condensation and dispersion step (S2), a alkali catalyst solution is added to the mixed solution to perform a condensation reaction under stirring to obtain a condensation solution, and then the condensation solution is added with a large amount of dispersing water solution and rapidly stirred by using an emulsifier or a homogenizer so that the condensation solution is dispersed in the dispersing water solution. During the condensation reaction, sub-micron condensation droplets are formed in the large amount of dispersing water solution; then by continuously stirring the condensation solution system containing the sub-micron condensation droplets, the sub-micron condensation droplets form an surface-stable aerogel wet-gel particle gradually, and the aerogel wet-gel particle is suspended and dispersed in the large amount of dispersing water solution;

One purpose of the condensation and dispersion step (S2) is to accelerate gelling rate of the sub-micron siloxane molecules or hydrophobic-modified siloxane molecules in the large amount of the dispersing solution so that the aerogel wet-gel particle of round-shape at nano-scale to sub-micron-scale can be formed in suspension; the other purpose of the condensation and dispersion step (S2) is to increase drying rate of the aerogel wet-gel particle in the subsequent drying process because small size of the aerogel wet-gel particle can significantly increase specific surface area thereof.

More preferably, at the condensation and dispersion step (S2), in the aerogel wet-gel particle sized of nanometers to sub-micrometers, the mixture of the siloxane compounds and the hydrophobic-modified siloxane compounds in the dispersing water solution can form the aerogel wet-gel particle due to large amount of the hydrophobic-modified siloxane comprising alkyl groups of variable chain lengths, and the aerogel wet-gel particle has stable gelled hydrophobic surface and is homogeneously dispersed in dispersing water solution.

During the condensation and dispersion processes, the aerogel wet-gel particle sized of nanometers to sub-micrometers forms a stable suspending particle and remains un-dissolved in the dispersing water solution, so addition of a large amount of hydrophobic organic solvent such as toluene or n-hexane can be dispensed, or multiple solvent replacement steps to remove the hydrophobic organic solvent can be avoided when the aerogel particle having a large amount of porosity is prepared.

Preferably, the atmospheric drying step (S3) comprises:
a solvent vaporizing step (S3-1): filtering the dispersing water solution suspending the surface-stable aerogel wet-gel particle by using a filtration machine, and the surface-stable aerogel wet-gel particle is filtered; then providing an air flow having a drying temperature at atmospheric pressure in a drying tank to rapidly evaporate the remaining water and alcohol solvents from the surface-stable aerogel wet-gel particle so as to obtain a dried aerogel particle; therefore, through atmospheric high-temperature air flow drying technology, the dried aerogel particle having porous structure, low thermal conductivity and high fireproof can be obtained; Combining minimizing sizes of the aerogel wet-gel particle and addition of hydrophobic alkyl groups of variable chain lengths, water molecules and alcohol molecules inside the aerogel wet-gel particle can be rapidly azeotropically dried, and an azeotropic vaporizing temperature of a solvent mixture comprising water and alcohol inside the aerogel wet-gel particle ranges from 60 to 100° C.;
a recycling step (S3-2): at the azeotropic vaporizing temperature, guiding vapors of the solvent mixture to a heat-exchange recycle equipment; in the heat-exchange recycle equipment, the solvent mixture is condensed and recycled so that the manufacturing cost and environmental pollutions can be reduced; and
Solvent bumping step (S3-3): adjusting the drying temperature of the aerogel wet-gel particle to a bumping temperature of the solvent mixture or above, and combining microwave to make water molecules in the aerogel structure to rapidly spin and disrupt hydrogen bonds thereof; the rapid spinning of the solvent molecules provides friction heat so that the remaining solvent mixture in the nearly dried aerogel wet-gel particle bumps rapidly to generate a positive pressure; with the positive pressure inside the nearly dried aerogel wet-gel particle, a swelling phenomenon happens from inside the nearly dried aerogel wet-gel particle and therefore produces a large amount of micropores at nano- to sub-micron scale; the micropores enhances porosity and thermal insulating property of the dried aerogel particle as well as aerogel products; preferably, the bumping temperature ranges from 100 to 180° C.

Preferably, at the high-temperature-resistant glue mixing step (S4), a high-temperature-resistant glue solution can be prepared, and under gently stirring, the dried aerogel particle is added to the high-temperature-resistant glue solution; a wetting agent, a de-bubbling agent and a dispersing agent can also be added to the high-temperature-resistant glue solution so that the dried aerogel particle is dispersed and impregnated in the high-temperature-resistant glue solution; the high-temperature-resistant glue solution comprises a high-temperature-resistant glue material, able to resist a high temperature above 500° C., comprising a pure inorganic glue material, an organic glue material, an inorganic glue material blending an organic material, a thermosetting resin or any combination thereof.

More preferably, the high-temperature-resistant glue material comprises a pure inorganic glue material or a large amount of inorganic glue material blending a trace amount of organic material; for example, the inorganic glue material blending an organic material comprises 45 to 97 v/v % inorganic glue material and 3 to 55 v/v % organic glue material, wherein the organic glue material is an organic thermosetting resin; more preferably, the inorganic glue material comprises water glass, silica oligomolecules, aluminum hydroxide molecules, inorganic silicone resin, copper oxide-phosphoric acid mixture, silicate molecules, inorganic silicon polymer, phosphoric acid-silicate mixture, magnesium oxide-silica-borax mixture, hollow silicon dioxide balls or any combination thereof.

More preferably, the organic glue material comprises high-temperature resistant silica gel, silicone-modified polyurethane, silicone-modified acrylic resin, silicone-modified polyvinyl alcohol, and organic thermosetting resin selected from epoxy resin, organic high-temperature resistant silicone resin, and hollow organic resin, hollow organic foam balls, silicone modified epoxy resin, or any combination thereof.

Preferably, at the homogenizing and dispersing step (S5), the high-temperature-resistant glue solution impregnating the dried aerogel particle is homogenized by using a stirring machine, and a wetting agent, a de-bubbling agent and a dispersing agent can be added to the high-temperature-resistant glue solution impregnating the dried aerogel particle to completely and homogeneously disperse the dried aerogel particle in the high-temperature-resistant glue solution, and therefore an aerogel fire-proof and heat-insulating paint is obtained. By the aforementioned steps, a silicone-based aerogel fire-proof and heat-insulating paint being smoke-free, toxic-free, highly fire-proof and highly thermal insulative can be obtained.

One object of the present invention is to provide a method for making the aerogel fire-proof and heat-insulating paint to improve drawbacks of traditional aerogel organic paint or thermally-expanded metal oxide organic fireproof paint; the aerogel fire-proof and heat-insulating paint presents excellent adherent property to metallic or plastic plates, and being smoke-free, toxic-free, highly fireproof and highly thermal insulative under high-temperature flame.

Another object of the present invention is to provide a method for making an aerogel fire-proof and heat-insulating paint to improve fire-proof door or a roll-up door, when sprayed of the aerogel fire-proof and heat-insulating paint and being burned by a high temperature flame from 850 to 1200° C. for more 3 hours s, the rear side of iron or aluminum plates of the fire-proof door or the roll-up door can be maintained below 400° C.

Yet another object of the present invention is to provide a method for making an aerogel fire-proof and heat-insulating paint suitable for application in thermal insulative layer or thermal insulative fire-proof layer on outer surface of a high-temperature furnace or a high-speed military aerospace vehicle; the aerogel fire-proof and heat-insulating paint can block thermal loss from inside the pipeline or surface of the equipment so that carbon reduction is achieved; the aerogel fire-proof and heat-insulating paint can also block the massive heat produced by air friction so that damage of internal precision detection components of the high-speed military aerospace vehicle can be minimized.

The aerogel fire-proof and heat-insulating paint provided in the present invention is suitable for thermal runaway or insulating thermal dissipation of lithium battery module in electric automobiles; the aerogel fire-proof and heat-insulating paint is sprayed on outer shell of the electric automobile lithium battery modules or electric automobile chassis so as to prevent rapid heat conduction from the electric automobile chassis to driver's cabinet resulting from thermal runaway of lithium battery modules in electric automobile, and safety of personnels in the electric automobile can thus be ensured.

In some embodiments, the dried aerogel particle inside the aerogel fire-proof and heat-insulating paint comprises a porous structure, and the porosity of the dried aerogel particle ranges from 50.0 to 95.0%. In some preferred embodiments, the porosity of the dried aerogel particle ranges from 50.0 to 75.0%. In other preferred embodiments, the porosity of the dried aerogel particle ranges from 75.0 to 95.0%. The density of the dried aerogel particle ranges from 0.06 to 0.12 g/cm³, and the thermal conductive coefficient of the dried aerogel particle ranges from 0.016 to 0.045 W/mK. In some preferred embodiments, the thermal conductive coefficient of the dried aerogel particle ranges from 0.016 to 0.025 W/mK. The dielectric constant of the dried aerogel particle ranges from 1.30 to 1.85, the flame resistance thereof is from UL94-V0 to UL94-5VA.

In some embodiments, the aerogel fire-proof and heat-insulating paint is further combined with a high thermal resistant inorganic glue, or an inorganic/organic mixed glue material so as to form a high thermal insulative and high fire-proof aerogel inorganic fire-proof paint; when the high thermal insulative and high fire-proof aerogel inorganic fire-proof paint is sprayed onto a front side of an aluminum plate to 150 to 200 micrometers thick and dried, and then being burned by a 1200° C. flame for at least for 5 minutes, temperature on the rear side of the aluminum plate is 300 to 350° C., while the aluminum plate would not penetrated; in contrast, another aluminum plate, unsprayed of the high thermal insulative and high fire-proof aerogel inorganic fire-proof paint, is penetrated when the front side of the another aluminum plate is burned by the 1200° C. flame for 1 minute, and temperature on the rear side of the another aluminum plate is 950 to 1050° C., which indicates the excellent fire-proof and thermal insulative properties of the aerogel fire-proof and heat-insulating paint.

The method provided in the present invention demonstrates the following effects:
1. The preparation method provided in the present invention improves the shortcomings of high-temperature fire protection of traditional aerogel thermal insulation paints and thermal expansion organic paints, and promotes the wide application of aerogel thermal insulation materials, and prepares an aerogel fire-proof and heat-insulating paint being smoke-free, non-toxic, highly fire-proof and highly thermal insulative under high-temperature flames. Aerogel particles are prepared using improved sol-gel suspension and dispersion technology, and no large amounts of organic solvents, surfactants, adhesives, etc. are required during the process. Long-term solvent replacement and the use of supercritical drying technology are not required for making the aerogel particles. The solvent recycle only needs atmospheric pressure and high-temperature airflow drying technology, an aerogel particle with high porosity can be rapidly prepared thereby. The overall process is simple, and highly safe and more economically advantageous. Batch process speed can be reduced to 4 to 10 hours to complete sub-micron aerogel products, and fluidized bed dynamic drying or high-temperature airflow drying technology can also be used to continuously produce aerogel particles, which improves production efficiency.
2. The preparation method provided in the present invention takes advantage of regulating factors such as the ratio of siloxane compounds and siloxane compounds comprising alkyl groups of variable chain lengths, the content of hydrolysis solvents, the content of dispersing water solution, stirring rate of an emulsifier or a homogenizer, content and ratio of acid catalyst and alkali catalyst to easily control the porosity and pore size inside the porous aerogel particles, the porosity between the aerogel particles and the compactness of the aerogel structure.
3. The preparation method provided in the present invention takes advantage of the repulsive force of hydrophilic-hydrophobic properties and rapid stirring of the siloxane compounds and the hydrophobic-modified siloxane compounds comprising alkyl groups of variable chain lengths to form aerogel wet-gel particles at nano- to micron-scale so that the drying rate of the aerogel wet-gel particles is increased and shrinkage properties thereof is reduced; therefore, no other hydrophobic organic solvents are added except alcohols, such as cyclohexane, benzene, isopropyl alcohol, ammonia, or a large amount of surfactants, etc. Moreover, the acid catalyst and the alkali catalyst are controlled at very low concentrations, which can further regulate the thermal conductivity, fireproof properties and dielectric properties of the aerogel material, thereby reducing the manufacturing cost of aerogel composite materials.
4. The preparation method provided in the present invention takes advantage of an emulsifier or a homogenizer to perform rapid condensation and dispersion, and gelling the condensation and dispersion solution thereby; thus, droplets comprising the siloxane compounds and hydrophobic-modified siloxane compounds having alkyl groups of variable chain lengths form aerogel wet-gel particles with a stable hydrophobic surface layer in a large amount of dispersion water solution; furthermore, in the subsequent gelation process, the interior of the aerogel wet-gel particles form a phase-separated structure due to hydrophilic-hydrophobic repulsion phenomenon, and network aerogel structure is further formed thereby; the hydrophobic-modified siloxane compounds having alkyl groups of variable chain lengths inside the aerogel wet-gel particles are distributed at the molecular level, making the aerogel wet-gel particles have excellent hydrophobic properties. In the subsequent atmospheric drying step, the aerogel particles with different pore sizes can be prepared. Compared with other technologies, the method provided in the present invention is not only organic solvent-saving, but also time-saving.
5. In order to address the shortcomings of traditional aerogel organic paints, the present invention, on one hand, improves the previous aerogel process technology, and also develops the use of inorganic glue or inorganic glue to prepare organic glue materials so as to formulate the high-temperature-resistant glue solution; the formulated high-temperature-resistant glue solution release no smoke or odor under high-temperature flame of 1200° C.; the aerogel fire-proof and heat-insulating paint can be combined with different materials such as metals, ceramics, plastics, inorganic fibers, and organic fibers. etc.; the aerogel particles are then mixed with the formulated high-temperature-resistant glue solution, so that heat insulation is achieved by the pores of the aerogel particles, and high-temperature resistance and fireproof is achieved by the high-temperature-resistant glue solution, and thus the aerogel fire-proof and heat-insulating paint being smoke-free, non-toxic, highly fire-proof and highly thermal insulative under high-temperature flames is formed thereby. Based on this technology, the aerogel fire-proof and heat-insulating paint can be applied in prevention of thermal runaway or heat dissipation of lithium battery modules in the electric automobiles. Being sprayed on the shell of lithium battery modules or chassis of the electric automobile, the aerogel fire-proof and heat-insulating paint can prevent the high temperature and massive heat caused by the thermal runaway of lithium battery modules from quickly penetrating into the driver's cabinet through the chassis of electric automobiles, which ensures safety of personnels in the electric automobiles.
6. The preparation method provided in the present invention improves the flame resistance of a traditional fire-proof door or a fire-proof roll-up door; when sprayed of the aerogel fire-proof and heat-insulating paint, and being burned by high-temperature flames of 850 to 1050° C. for more 3 hours, the rear side of iron plates of the fire-proof door or the fire-proof roll-up door can be maintained below 1200° C.; on the other hand, the aerogel fire-proof and heat-insulating paint made by the method provided in the present invention is also suitable for application in a fire-proof layer on outer surface of a high-temperature furnace, or a thermal insulative layer or a thermal insulative fire-resistant layer of a high-speed military aerospace vehicle; the aerogel fire-proof and heat-insulating paint can block the massive heat produced by air friction so as to minimize damage of internal precision detection components of the high-speed military aerospace vehicle; in the aforementioned aerogel fire-proof and heat-insulating paint, the dried aerogel particle comprises a porous structure having porosity from 75.0 to 95.0%, the density thereof ranges from 0.06 to 0.12 g/cm³, the thermal conductive coefficient ranges from 0.016 to 0.025 W/mK, the dielectric constant thereof ranges from 1.30 to 1.85, the flame resistance thereof is from UL94-V0 to UL94-5VA.

The aforementioned aerogel fire-proof and heat-insulating paint combines a high-temperature-resistant inorganic glue material or an inorganic/organic glue mixture material to formulated a high thermal insulative and high fire-proof aerogel inorganic fire-proof paint; with the aerogel fire-proof and heat-insulating paint sprayed onto an aluminum plate to 150 to 200 micrometers thick and dried, the aluminum plate can tolerate burning by a 1200° C. flame for at least 30 minutes, and temperature on the rear side of the aluminum plate can be maintained at 300 to 350° C.; in contrast, another aluminum plate unsprayed of the aerogel fire-proof and heat-insulating paint is penetrated when the surface is burned by the 1200° C. flame for 1 minute, which indicates the excellent fire-proof and thermal insulative properties of the aerogel fire-proof and heat-insulating paint.

### BRIEF DESCRIPTION OF DRAWINGS

FIG. 1 is a flowchart to illustrate the first embodiment of the method for making an aerogel fire-proof and heat-insulating paint being smoke-free, non-toxic, highly fire-proof and highly thermal insulative under high-temperature flames;

FIG. 2 is an appearance photo of the aerogel particles having high thermal insulative effect and low density prepared by the method in the first embodiment;

FIG. 3 is a scanning electron microscope (SEM) photo of the aerogel particles having high thermal insulative effect and low density prepared by the method in the first embodiment, and the magnification was 10,000×;

FIG. 4 is an appearance photo of the aerogel fire-proof and heat-insulating paint, prepared by the method in the first embodiment, being smoke-free, non-toxic, highly fire-proof and highly thermal insulative under high-temperature flames;

FIG. 5 is a SEM photo of a sectional view of a fire-proof coating made of the aerogel fire-proof and heat-insulating paint, prepared by the method in the first embodiment, being smoke-free, non-toxic, highly fire-proof and highly thermal insulative under high-temperature flames, and the magnification was 5,000×;

FIG. 6 is an appearance photo to demonstrate a normal aluminum plate of 1 mm thickness prior to and post burning by flames of 1200° C.;

FIG. 7 is an appearance photo to demonstrate an aluminum plate sprayed of the aerogel fire-proof and heat-insulating paint, prepared by the method in the first embodiment, being smoke-free, non-toxic, highly fire-proof and highly thermal insulative under high-temperature flames, prior to and post burning by flames of 1200° C.

FIG. 8 presents a schematic diagram of the locations for detecting temperatures at both sides of the aluminum plate painted with the aerogel fire-proof and heat-insulating paint.

FIG. 9 presents a line graph to illustrate temperature variations at both sides of the aluminum plate under burning of flames.

### DETAILED DESCRIPTIONS OF THE INVENTION

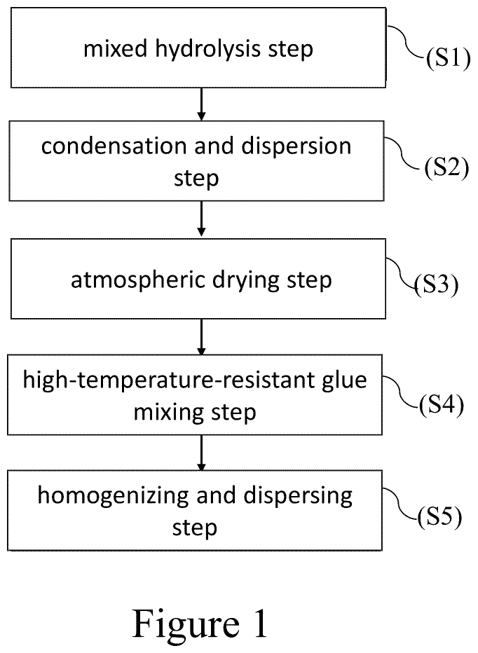

Please refer to FIG. 1, the first embodiment of the method for making an aerogel fire-proof and heat-insulating paint in the present invention, wherein the aerogel fire-proof and heat-insulating paint is formed of aerogel particles having various sizes and hydrophobicity/hydrophilicity in addition with an inorganic gelling solution or an organic gelling solution, and the aerogel fire-proof and heat-insulating paint is smoke-free, non-toxic, highly fire-proof and highly thermal insulative under high-temperature flames. In the first embodiment the method comprises a mixed hydrolysis step (S1), a condensation and dispersion step (S2), an atmospheric drying step (S3), a high-temperature-resistant glue mixing step (S4) and a homogenizing and dispersing step (S5).

In the mixed hydrolysis step (S1), siloxane precursors is added to an ethanol water solution so as to form a mixed solution, wherein the siloxane precursors comprise hydrophobic-modified siloxane compounds, siloxane compounds or a combination thereof; and then adding an acid catalyst to the mixed solution so that the siloxane precursors are hydrolyzed into a hydrolyzed siloxane compound mixture; in some exemplary embodiments, the siloxane compounds comprise tetramethoxysilane (TMOS), tetraethoxysilane (TEOS) or a combination thereof.

In some examples, the hydrophobic-modified siloxane compounds comprise hydrophobic-modified siloxane compounds having alkyl groups of variable chain lengths, for example, the hydrophobic-modified siloxane compounds can be methyltrimethoxysilane (MTMS), propyltrimethoxysilane (PTMS), hexyltrimethoxysilane (HTMS), octyltrimethoxysilane (OTMS), hexamethyldisilazane (HMDS) or any combination thereof, but not limited to this.

In particular, the purpose of adding the hydrophobic-modified siloxane compounds of is to minimize shrinkage and cracking of the aerogel structure during drying process, and the purpose of adding the siloxane compounds is to regulate internal microstructure so as to increase the amount of porous structure.

In the aforementioned examples, based on the entire mixed solution as a whole, the total molar content of the siloxane compounds and the hydrophobic-modified siloxane compounds ranges from 0.5 mol % to 40 mol %, and the molar ratio of the ethanol water solution ranges from 99.5 mol % to 60 mol %.

In the first embodiment, the molar ratio of the siloxane compounds to the hydrophobic-modified siloxane compounds ranges from (0:100) to (95:5); in some preferred examples, the molar ratio of the siloxane compound to the hydrophobic-modified siloxane compound is 5:95; in the ethanol water solution, the molar ratio of ethanol to water ranges from 0:100 to 50:50; in some preferred examples, the molar ratio of ethanol to water is 15:85.

In the mixed hydrolysis step (S1), the siloxane compounds, the hydrophobic-modified siloxane compounds and a large amount of ethanol water solution containing a trace amount of acid catalyst are thoroughly mixed; during the mixing process, hydrolysis happens simultaneously, wherein the ethanol water solution containing a trace amount of acid catalyst comprises ethanol, deionized water, treated water, secondary treated water or any combination thereof, and the molar ratio of the mixed solution containing the siloxane compounds and the hydrophobic-modified siloxane compounds to the acid catalyst ranges from 1:0.01 to 1:0.0005; the higher the content of acid catalyst in the mixed solution, the faster the hydrolysis; on the other hand, the higher the content of acid catalyst, the larger the ionic contents in the entire aerogel structure, and the dielectric loss of the aerogel would be more; in one preferred example, the molar ratio of the mixed solution containing the siloxane compounds and the hydrophobic-modified siloxane compounds to the acid catalyst ranges from 1:0.0015.

In the condensation and dispersion step (S2), an alkali catalyst solution is added to the mixed solution to perform a condensation reaction under homogeneous stirring to obtain a condensation solution, and then adding a large amount of dispersing water solution to the condensation solution, and rapidly stirring the dispersing water solution and the condensation solution by using an emulsifier or a homogenizer, so that the condensation solution is dispersed in the dispersing water solution. The hydrolyzed siloxane compounds mixture in the condensation solution undergoes another condensation reaction to form sol gel droplets; the sol-gel droplets are sub-micron condensation droplets suspended in the dispersing water solution; then by continuously stirring the condensation solution system containing the sub-micron condensation droplets, and the sub-micron condensation droplets form an surface-stable aerogel wet-gel particle gradually through gelation, and the aerogel wet-gel particle is suspended and dispersed in the large amount of dispersing water solution; preferably, the volume ratio of the dispersing water solution to the ethanol water solution ranges from 100:0 to 30:70; in some preferred examples, the volume ratio of the dispersing water solution to the ethanol water solution ranges from 100:0.

In some examples, rising temperature can significantly reduce time of condensation reaction; that is to say, gelation time of aerogel in the condensation and dispersion step (S2) can be effectively reduced; in some examples, when the content equivalent ratio of the alkali catalyst to the acid catalyst is 1.0:1.0, the condensation temperature is 20 to 55° C., the condensation time ranges from 20 to 250 minutes; in some preferred examples, the condensation temperature is 25° C., the condensation time is around 220 minutes, and when the condensation temperature is 50° C., the condensation time is around 15 minutes.

In the condensation and dispersion step (S2), the aerogel wet-gel particle sized of nanometers to sub-micrometers contains a large amount of the hydrophobic-modified siloxane compounds having alkyl groups of variable chain lengths, and thus in the dispersing water solution the mixture of the siloxane compounds and the hydrophobic-modified siloxane compounds can form a stable gelled surface layer. Sizes of the initial structures of the siloxane aerogel molecules and the hydrophobic-modified siloxane compounds inside the aerogel wet-gel particle can be controlled within 5 to 10 nm. These initial structures can be accumulated into the aerogel wet-gel particle sized of 50 to 100 nm, and interconnect each other to form a 3D network structure. Therefore, during the condensation and dispersion processes, these aerogel wet-gel particle sized of nanometers to sub-micrometers can form a stable suspending particle and remains un-dissolved in the dispersing water solution; hence, addition of a large amount of hydrophobic organic solvent such as toluene or n-hexane can be dispensed, or multiple solvent replacement steps to remove the hydrophobic organic solvent can be avoided when the aerogel particle having a large amount of porosity is prepared.

In some examples, the volume ratio of the mixture containing the siloxane compounds and the hydrophobic-modified siloxane compounds to the dispersing water solution ranges from (1.0:1.0) to (1.0:5.0); in some particular examples, the volume ratio is 1.0:1.0, the condensation time is 70 minutes; preferably, the volume ratio is 1.0:3.0, the condensation time is 30 minutes; more preferably, the volume ratio is 1.0:1.5, the condensation time is 55 minutes, which has the highest productivity of aerogel particles.

Preferably, the atmospheric drying step (S3) comprises a solvent vaporizing step (S3-1), a recycling step (S3-2) and a solvent bumping step (S3-3).

In the atmospheric drying step (S3), the dispersing water solution suspending the surface-stable and sub-micron aerogel wet-gel particle is filtered by using a filtration machine, and the sub-micron aerogel wet-gel particle is obtained; then an air flow having a drying temperature at atmospheric pressure is provided in a drying tank to rapidly evaporate the remaining dispersing water solution containing water and alcohol from the surface-stable and sub-micron aerogel wet-gel particle so as to obtain a dried aerogel particle. Because the surface-stable and sub-micron aerogel wet-gel particle contains a large amount of hydrophobic structure comprising alkyl groups of variable chain lengths, shrinkage and cracking of aerogel structure lead by water interfacial tension in the aerogel wet-gel particle can be suppressed during drying process. Preferably, the drying temperature ranges from 60 to 150° C.; in other preferred embodiments, the drying temperature ranges from 60 to 90° C., 90 to 120° C. or 120 to 150° C.

Thus, the dried aerogel particle with porous structure, low heat conduction and high fire resistance can be quickly obtained by the atmospheric high-temperature air flow drying technology. With reduced sizes of the aerogel particles and addition of a large amount of hydrophobic alkyl groups of variable chain lengths, water molecules and alcohol molecules inside the aerogel structure can be rapidly dried.

In some examples, the azeotropic vaporizing temperature of the solvent mixture comprising water and alcohol inside the aerogel wet-gel particle ranges from 60 to 100° C.; preferably, the azeotropic vaporizing temperature ranges from 75 to 90° C.; more preferably, the azeotropic vaporizing temperature ranges from 80 to 85° C.; in some preferred embodiments, the azeotropic vaporizing temperature is 83° C.

In some particular examples, a solvent recycle equipment can be designed for conducting the recycling step (S3-2). At the azeotropic vaporizing temperature, vapors of the solvent mixture are guided to a heat-exchange recycle equipment during the atmospheric high-temperature air flow drying process. In the heat-exchange recycle equipment, the solvent mixture containing water and alcohol is condensed and recycled so that the manufacturing cost and environmental pollutions can be reduced.

In the solvent bumping step (S3-3), when most of the solvent mixture containing water and alcohol inside the aerogel wet-gel particle is evaporated and the nearly dried aerogel wet-gel particle is obtained, adjusting the drying temperature of the nearly dried aerogel wet-gel particle to a bumping temperature of the solvent mixture or above. in some examples, with microwaves, water molecules in the aerogel structure are rapidly spined and hydrogen bonds between the water molecules are disrupted so that friction heat is provided. The friction heat makes the remaining solvent mixture in the nearly dried aerogel wet-gel particle bumps rapidly to generate a positive pressure. With the positive pressure inside the nearly dried aerogel wet-gel particle, a swelling phenomenon happens from inside the nearly dried aerogel wet-gel particle and therefore produces a large amount of micropores at nano- to sub-micron scale, and dried aerogel particle is obtained thereby. the micropores enhances porosity and thermal insulating property of the dried aerogel particle as well as aerogel products in the rear end. Preferably, the bumping temperature ranges from 100 to 180° C.; more preferably, the bumping temperature ranges from 150 to 180° C.

On the other hand, without addition of a large amount of organic solvents such as alkanes, aromatic benzene, amines and surfactants, the drying process is much safer, and aerogel products with higher purity can be prepared; the dried aerogel particle with high porosity contains no impurities, so products in the rear end demonstrate more excellent properties including thermal insulation, dielectric constant and dielectric loss.

In the homogenizing and dispersing step (S4), a high-temperature-resistant glue solution able to tolerate a high temperature above 500° C. is prepared, and under gently stirring, the dried aerogel particle is added to the high-temperature-resistant glue solution. Under gently stirring, the dried aerogel particle is dispersed and impregnated in the high-temperature-resistant glue solution. The high-temperature-resistant glue solution comprises a high-temperature-resistant glue material, able to resist a high temperature above 500° C., comprising a pure inorganic glue material, an organic glue material, an inorganic glue material blending an organic glue material, an inorganic glue material containing a trace amount of organic glue material, a thermosetting resin or any combination thereof; exemplarily, the inorganic glue material containing a trace amount of organic glue material can be 45 to 97 v/v % inorganic glue material blending 3 to 55 v/v % organic glue material.

In preferred examples, the inorganic glue material comprises water glass, silica oligomolecules, aluminum hydroxide molecules, inorganic silicone resin, copper oxide-phosphoric acid mixture, silicate molecules, inorganic silicon polymer, phosphoric acid-silicate mixture, magnesium oxide-silica-borax mixture, hollow silicon dioxide balls or any combination thereof; the organic glue material comprises high-temperature resistant silica gel, silicone-modified polyurethane, silicone-modified acrylic resin, silicone-modified polyvinyl alcohol, and organic thermosetting resin selected from epoxy resin, organic high-temperature resistant silicone resin, and hollow organic resin, hollow organic foam balls, silicone modified epoxy resin, or any combination thereof.

In some preferred examples, based on the aerogel fire-proof and heat-insulating paint as a whole, the weight percentage of the dried aerogel particles ranges from 10.0 to 45.0 wt %, the weight percentage of the high-temperature-resistant glue solution ranges from 55.0 to 90.0 wt %; when the weight percentage of the high-temperature-resistant glue solution is lower, adherent strength of the aerogel fire-proof and heat-insulating paint to metals, ceramics, or plastics is reduced, and thermal insulative property thereof is better. In contrast, when the weight percentage of the high-temperature-resistant glue solution is higher, adherent strength of the aerogel fire-proof and heat-insulating paint to metals, ceramics or plastics is higher, and the aerogel fire-proof and heat-insulating paint presents better fire-proof function at high temperature, being more compact, but presents worse thermal insulation property, and demonstrates vertical flow when sprayed onto a substrate. Therefore, to optimize the aerogel fire-proof and heat-insulating paint so as to be smoke-free, non-toxic, highly thermal insulative and highly fire-proof. Preferably, weight percentage of the dried aerogel particle ranges from 13.0 to 25.0 wt %. More preferably, weight percentage of the dried aerogel particle ranges from 13.0 to 15.0 wt % or 15.0 to 25.0 wt %.

In the homogenizing and dispersing step (S5), the high-temperature-resistant glue solution impregnating the dried aerogel particle is homogenized by using a stirring machine. In some examples, a wetting agent, a de-bubbling agent, a dispersing agent or any combination thereof can also be added to the high-temperature-resistant glue solution impregnating the dried aerogel particle to completely and homogeneously disperse the dried aerogel particle in the high-temperature-resistant glue solution so as to form the aerogel fire-proof and heat-insulating paint in a homogeneous status. Through the aforementioned steps, the silicone-based aerogel fire-proof and heat-insulating paint presents properties as being smoke-free, non-toxic, highly fire-proof and high thermal insulative.

The primary object of the present invention is to provide a method for making the aerogel fire-proof and heat-insulating paint improving drawbacks of traditional aerogel organic paint or thermally-expanded metal oxide organic fireproof paint, so that the aerogel fire-proof and heat-insulating paint presenting excellent adherent property to metallic or plastic plates can be prepared, and the aerogel fire-proof and heat-insulating paint is also smoke-free, toxic-free, highly fireproof and highly thermal insulative under high-temperature flame.

The aerogel fire-proof and heat-insulating paint can further be used to improve severe deformation issues of traditional fire-proof doors or roll-up doors under high-temperature flames; when sprayed of the aerogel fire-proof and heat-insulating paint and being burned by a high temperature flame from 850 to 1200° C. for more 3 hours, the rear side of iron or aluminum plates of the fire-proof doors or the roll-up doors can be maintained below 400° C.; in one more aspect, the aerogel fire-proof and heat-insulating paint provided in the present invention is especially suitable for insulation against thermal runaway or thermal dissipation of lithium battery modules in electric automobiles; the aerogel fire-proof and heat-insulating paint is sprayed on outer shell of the electric automobile lithium battery modules or electric automobile chassis so as to prevent rapid heat conduction from the electric automobile chassis to driver's cabinet resulting from thermal runaway of lithium battery modules in electric automobile, and safety of personnels in the electric automobile can thus be ensured.

Several embodiments are presented below with the drawings to illustrate the technical effects achieved by the method provided by the present invention.

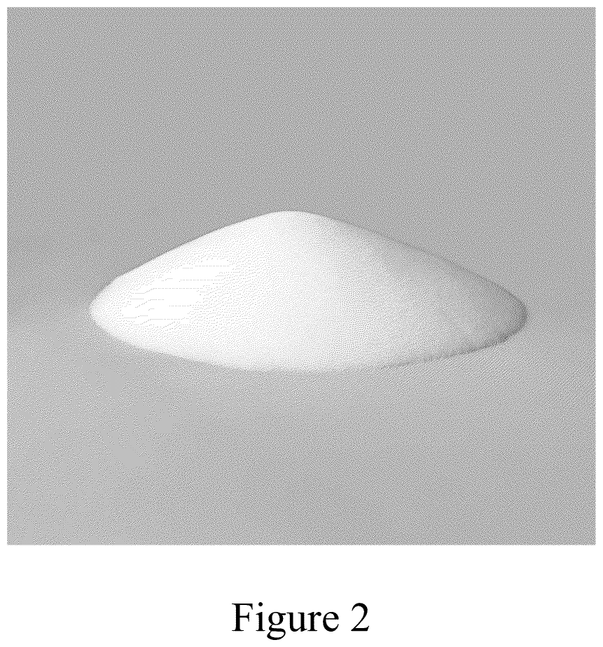

Please refer to FIG. 2, presented herein is an appearance photo of the aerogel particles, being highly thermal insulative and of low density, prepared by the method according to the first embodiment; FIG. 2 demonstrates that the prepared aerogel particles are white powder with excellent homogeneity.

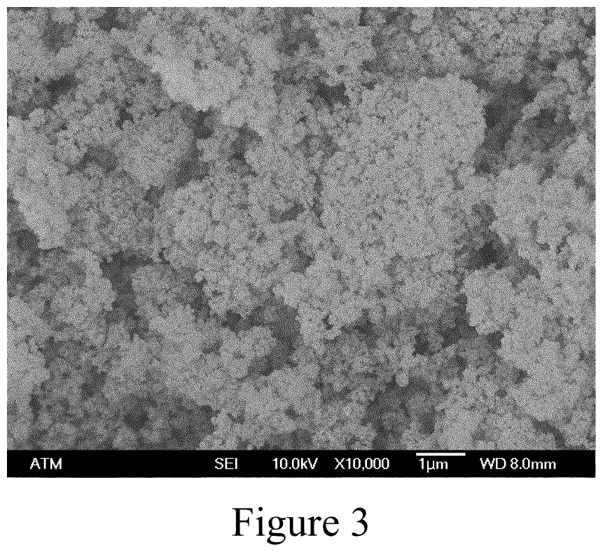

Please refer to FIG. 3, presented herein is a scanning electron microscope (SEM) photo of the aerogel particles having high thermal insulative effect and low density prepared by the method according to the first embodiment, and the magnification was 10,000×; under electronic microscopy, the microstructure of the aerogel particles are clearly round-shape, and sizes of the round-shape aerogel particles are about 100 to 200 nm, while sizes of the aggregates of the aerogel particles are sub-microns to dozens of microns.

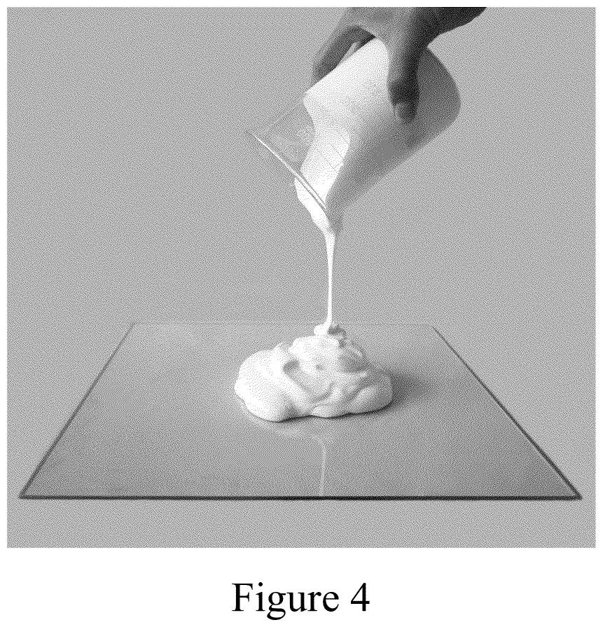

Please refer to FIG. 4, presented herein is an appearance photo of the aerogel fire-proof and heat-insulating paint, prepared by the method according to the first embodiment, being smoke-free, non-toxic, highly fire-proof and highly thermal insulative under high-temperature flames; specifically, the aerogel fire-proof and heat-insulating paint appears white and sticky, and the color thereof can be formulated to be black or other colors by using inorganic dye; the aerogel fire-proof and heat-insulating paint contains aerogel particles sized of sub-microns or dozens of microns so as to be high-temperature resistant and highly thermal insulative, and also contains high-temperature-resist glue material to provide high-temperature resistance, high adherent strength and high fireproof.

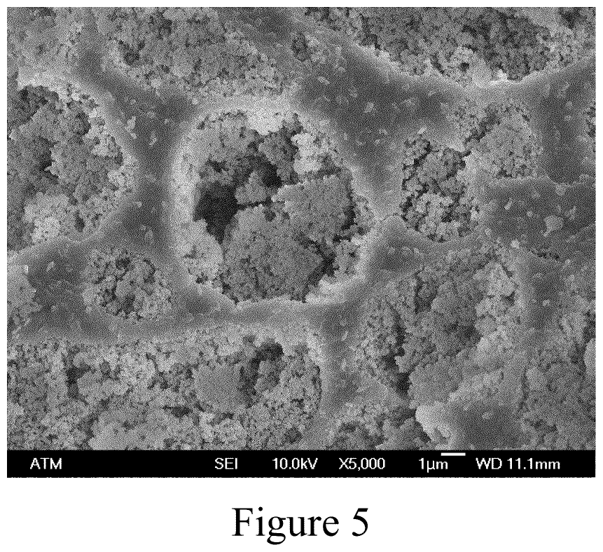

Please refer to FIG. 5, presented herein is a SEM photo of a sectional view of a fire-proof coating made of the aerogel fire-proof and heat-insulating paint, prepared by the method according to the first embodiment, being smoke-free, non-toxic, highly fire-proof and highly thermal insulative under high-temperature flames, and the magnification was 5,000×. FIG. 5 shows that the internal structure of the aerogel fire-proof and heat-insulating paint is a composite of the high-temperature-resistant glue encapsulating the aerogel aggregates sized of sub-microns to dozens of microns, and particularly a large amount of the sub-micron aerogel molecules aggregates are dispersed in the high-temperature-resistant glue; from the sectional view of the aerogel fire-proof and heat-insulating paint, a large amount of pores remain inside the aerogel molecule aggregates among the high-temperature-resistant glue; therefore, in the sectional structure of the entire aerogel fire-proof and heat-insulating paint, the large amount of the aerogel and the pores provides the aerogel fire-proof and heat-insulating paint properties of low thermal conductivity and high thermal insulation.

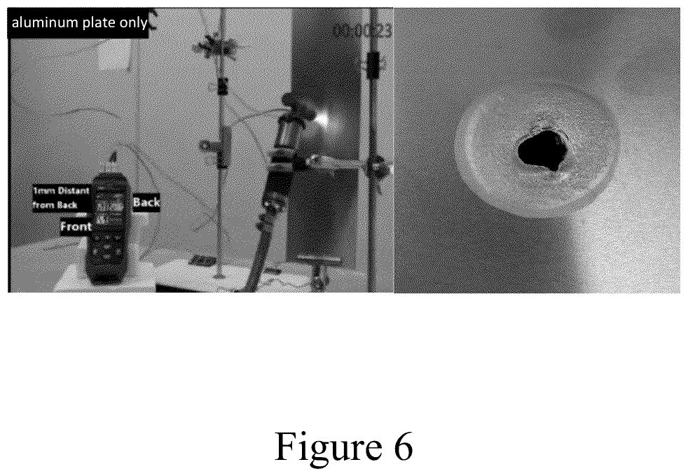

Please refer to FIG. 6, presented herein is an appearance photo to demonstrate a normal aluminum plate of 1 mm thickness prior to and post burning by flames of 1200° C.; the rear side of the normal aluminum plate reached 600° C. after being burned by flames of 1200° C. for 23 seconds, and the normal aluminum plate was penetrated after being burned by flames of 1200° C. for 1 minute, as indicated on the right panel in FIG. 6.

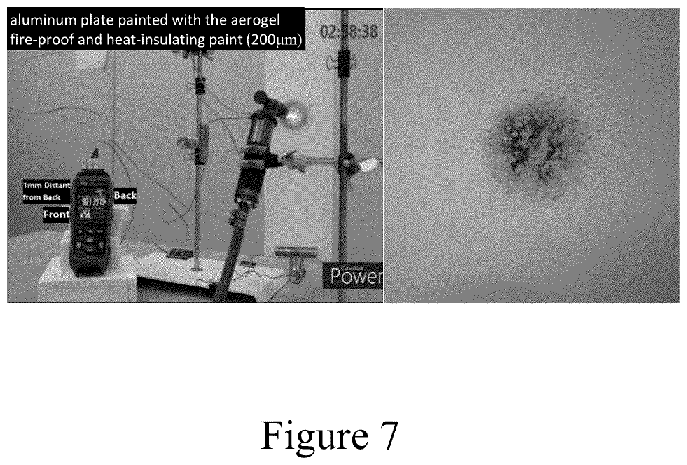

Please refer to FIG. 7, presented herein is an appearance photo to demonstrate an aluminum plate sprayed of the aerogel fire-proof and heat-insulating paint, prepared by the method in the first embodiment, being smoke-free, non-toxic, highly fire-proof and highly thermal insulative under high-temperature flames, prior to and post burning by flames of 1200° C. for 3 hours (180 minutes). Specifically, spraying thickness of the aerogel fire-proof and heat-insulating paint is about 200 micrometers, and demonstrated here is the temperature on the rear side of the painted aluminum plate under burning of flames of 1200° C. for 3 hours and the painted aluminum plate was unpenetrated after being burned; as shown in the right panel of FIG. 7.

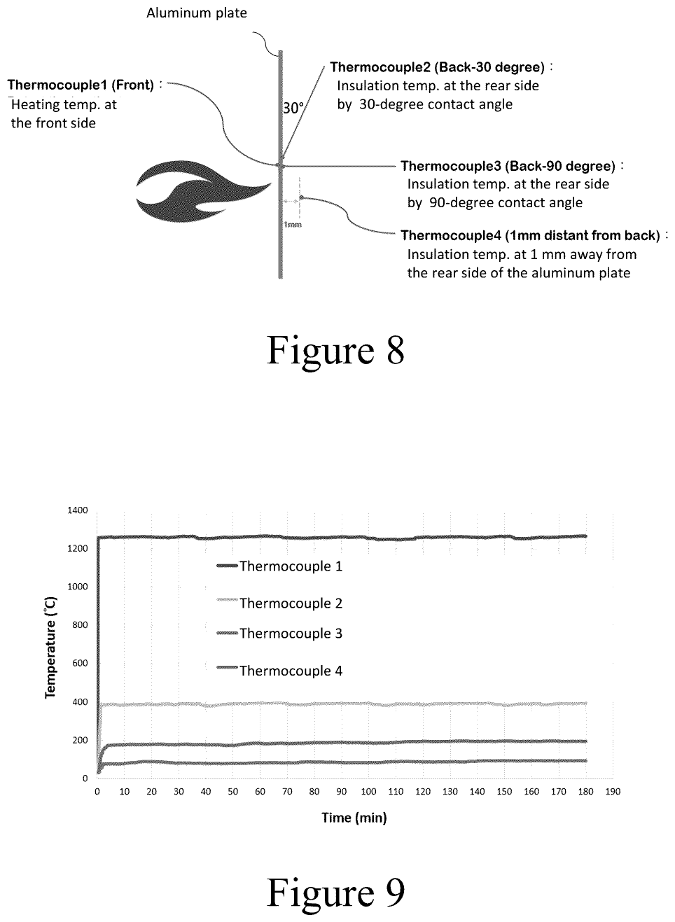

Please refer to FIG. 8, presented herein is a schematic diagram of the locations for detecting temperatures at both sides of the aluminum plate painted with the aerogel fire-proof and heat-insulating paint. Specifically, the thermocouple 1 detects the temperature of flames at the front side of the aluminum plate. The thermocouple 2 detects the insulation temperature at the rear side of the aluminum plate by 30-degree contact angle. The thermocouple 3 detects the insulation temperature at the rear side of the aluminum plate by 90-degree contact angle. The thermocouple 4 detects the insulation temperature at the location 1 mm away from the rear side of the aluminum plate. All the thermocouples detect temperatures when the aluminum plate was under burning of flames.

Please refer to FIG. 9 representing a line graph to illustrate temperature variations at both sides of the aluminum plate under burning of flames. The heating temperature of the burning of flames was 1200° C. (indicated as Thermocouple 1), and the burning continued for 3 hours at the front side of the aluminum plate. In this exemplary embodiment, thickness of the aerogel fire-proof and heat-insulating paint sprayed on the aluminum plate was about 200 micrometers. The temperatures at the rear side of the painted aluminum plate detected by 30-degree and 90-degree contact angle were 380° C. (indicated as Thermocouple 2) and 180° C. (indicated as Thermocouple 3), respectively. Surprisingly, the aluminum plate were not penetrated under burning of 1200° C. flames for 3 hours. Such result indicates that the aerogel fire-proof and heat-insulating paint has highly fire-proof and highly thermal insulation effect. Moreover, the temperature at the rear side 1 mm away from the aluminum plate maintained 97° C. under burning of 1200° C. flames for 3 hours. Aerogel fire-proof and heat-insulating paint with such excellent safety factor has great potential use for as safety guard of the thermal runaway in electric vehicles. The exemplary data indicates that the painted aluminum plate with aerogel fire-proof and heat-insulating paint has an excellent smoke-free, non-toxic, fire-proof and thermal insulative effects, and being applicable for preventing thermal runaway of lithium battery modules in electric vehicle (EV).

In summary, the production, application and effects of the present invention should be clearly disclosed. However, the above-mentioned embodiments are only preferred embodiments of the present invention, and should not be used to limit the patent protection scope of the present invention. That is, according to the present invention Simple equivalent changes and modifications to the scope of patent protection and the description of the invention fall within the scope of patent protection of the present invention.

What is claimed is:

1. A method for making an aerogel fire-proof and heat-insulating paint, characterized by being formed of aerogel particles having various sizes and hydrophobicity/hydrophilicity in addition with an inorganic gelling solution or an organic gelling solution, comprising steps of:
a mixed hydrolysis step: adding a siloxane precursor to an ethanol water solution so as to form a mixed solution, and adding an acid catalyst to the mixed solution so that a hydrolysis reaction is performed, wherein the siloxane precursor comprises hydrophobic-modified siloxane compound having alkyl groups with chain of variable length, siloxane compound or a combination thereof;
a condensation and dispersion step: adding a alkali catalyst solution to the mixed solution to perform a condensation reaction so as to obtain a condensation solution, and adding a dispersing solution to the condensation solution, and then using an emulsifier or a homogenizer for rapid dispersion of the condensation solution so that hydrolyzed siloxane compound mixture in the condensation solution is condensed into sol droplets, wherein the sol droplets are suspended in the dispersing solution, and then the sol droplets are condensed into an aerogel wet gel particle having a steady hydrophobic shell and homogeneously dispersed in the dispersing solution;
an atmospheric drying step: at atmospheric pressure and a drying temperature, filtering the dispersing solution by using a filtration machine so as to obtain the aerogel wet gel particle, and then providing an air flow having the drying temperature at atmospheric pressure to rapidly evaporate remaining solvent from the aerogel wet gel particle so as to obtain a dried aerogel particle, wherein the drying temperature ranges from 60 to 150° C.;
a high-temperature-resistant glue mixing step: preparing a high-temperature-resistant glue solution and gently stirring the high-temperature-resistant glue solution, and adding the dried aerogel particle to the high-temperature-resistant glue solution; dispersing and impregnating the dried aerogel particle in the high-temperature-resistant glue solution with gentle stirring, wherein the high-temperature-resistant glue solution is able to resist a high temperature of at least 500° C.; and
a homogenizing and dispersing step: homogenizing the high-temperature-resistant glue solution dispersing and impregnating the dried aerogel particle by using a stirring machine; adding a wetting agent, a de-bubbling agent and a dispersing agent to the high-temperature-resistant glue solution dispersing and impregnating the dried aerogel particle to completely and homogeneously disperse the dried aerogel particle in the high-temperature-resistant glue solution so as to form an aerogel fire-proof and heat-insulating paint, wherein the aerogel fire-proof and heat-insulating paint presents functionalities including smoke-free, toxic-free, high fireproof and high thermal insulation.

2. The method according to claim 1, wherein the aerogel fire-proof and heat-insulating paint improves drawbacks of traditional aerogel organic paint or thermally-expanded metal oxide organic fireproof paint; the aerogel fire-proof and heat-insulating paint presents excellent adherent property to metallic, ceramics or plastic plates, and functionalities including smoke-free, toxic-free, high fireproof and high thermal insulation;
the aerogel fire-proof and heat-insulating paint is suitable for thermal runaway or insulation of thermal dissipation of battery module in electric automobiles; the aerogel fire-proof and heat-insulating paint is painted on outer shell of the electric automobile battery module or electric automobile chassis so as to prevent rapid heat conduction from the electric automobile chassis to driver's cabinet due to thermal runaway of the electric automobile battery module and increase safety of personnels in the electric automobile.

3. The method according to claim 1, wherein the atmospheric drying step comprises:
a solvent vaporizing step: at an azeotropic vaporizing temperature, rapidly azeotropically vaporizing the solvent in the structure of the aerogel wet gel particle to distilling dry the solvent so as to obtain a dried aerogel structure, wherein the azeotropic vaporizing temperature ranges from 60 to 100° C.; and
a solvent bumping step: adjusting the drying temperature to a bumping temperature so that the solvent in the dried aerogel structure bumps rapidly with water molecules to produce a positive vapor pressure so that dried condensation of the dried aerogel structure is suppressed and a large amount of micropores in the dried aerogel structure is produced, and obtaining the dried aerogel particle having higher thermal insulation property, wherein the bumping temperature ranges from 100 to 180° C.

4. The method according to claim 1, wherein the high-temperature-resistant glue solution comprises a pure inorganic glue material, an organic glue material, an inorganic glue material blending an organic material or any combination thereof, wherein the inorganic glue material comprises water glass, silica oligomolecules, aluminum hydroxide molecules, inorganic silicone resin, copper oxide-phosphoric acid mixture, silicate molecules, inorganic silicon polymer, phosphoric acid-silicate mixture, magnesium oxide-silica-borax mixture, hollow silicon dioxide balls or any combination thereof;
wherein the organic glue material comprises high-temperature resistant silica gel, silicone-modified polyurethane, silicone-modified acrylic resin, silicone-modified polyvinyl alcohol, and organic thermosetting resin selected from epoxy resin, organic high-temperature resistant silicone resin, and hollow organic resin, hollow organic foam balls, silicone modified epoxy resin, or any combination thereof.

5. The method according to claim 4, wherein the inorganic glue material blending an organic material comprises 45 to 97 v/v % inorganic glue material and 3 to 55 v/v % organic glue material.

6. The method according to claim 1, wherein the siloxane compound comprises tetramethoxysilane (TMOS), tetraethoxysilane (TEOS) or the combination thereof; the hydrophobic-modified siloxane compound comprises methyltrimethoxysilane, propyltrimethoxysilane, hexyltrimethoxysilane, octyltrimethoxysilane, hexamethyldisilazane or a combination of any two or more thereof, wherein in the siloxane precursor, a molar ratio of the siloxane compound to the hydrophobic-modified siloxane compound ranges from 0:100 to 95:5.

7. The method according to claim 1, wherein the homogenizing and dispersing step comprises: using a stirring-dispersion equipment to blend and disperse the high-temperature-resistant glue solution dispersing and impregnating the dried aerogel particle.

8. The method according to claim 1, wherein based on the aerogel fire-proof and heat-insulating paint as a whole, weight percentage of the dried aerogel particle ranges from 10.0 to 45.0 wt %, weight percentage of the high-temperature-resistant glue solution ranges from 55.0 to 90.0 wt %;
wherein the lower the weight percentage of the high-temperature-resistant glue solution, adherent strength of the aerogel fire-proof and heat-insulating paint to metals, ceramics or plastics is lower, and thermal insulation property thereof is better; on the contrary, the higher the weight percentage of the high-temperature-resistant glue solution, adherent strength of the aerogel fire-proof and heat-insulating paint to metals, ceramics or plastics is higher, and the aerogel fire-proof and heat-insulating paint presents better fireproof function at high temperature, being more compact, but presents worse thermal insulation property, and demonstrates vertical flow when sprayed onto a substrate.

9. The method according to claim 8, wherein weight percentage of the dried aerogel particle ranges from 15.0 to 25.0 wt %.

10. The method according to claim 1, wherein the dried aerogel particle inside the aerogel fire-proof and heat-insulating paint comprises a porous structure, wherein the porosity of the dried aerogel particle ranges from 75.0 to 95.0%, the density thereof ranges from 0.06 to 0.12 g/cm³, the thermal conductive coefficient thereof ranges from 0.016 to 0.025 W/mK, the dielectric constant thereof ranges from 1.30 to 1.85, the flame resistance thereof is from UL94-V0 to UL94-5VA;
wherein the aerogel fire-proof and heat-insulating paint is further combined with a high thermal resistant inorganic glue, or an inorganic/organic mixed glue material so as to form a high thermal insulative and high fire-proof aerogel inorganic fireproof paint, wherein when the high thermal insulative and high fire-proof aerogel inorganic fireproof paint is sprayed onto front side of an aluminum plate to 200 micrometer thick, and being burned by a 1200° C. flame for 3 hours (180 minutes), temperature on the rear side of the aluminum plate is 350 to 400° C., and temperature on the rear side distant from the aluminum plate 1 mm is lower than 100° C., while the aluminum plate is not penetrated by the 1200° C. flame for 3 hours;
in contrast, another aluminum plate unsprayed of the high thermal insulative and high fire-proof aerogel inorganic fireproof paint is penetrated when the front side of the another aluminum plate is burned by the 1200° C. flame for 1 minute.

11. The method according to claim 1, wherein the aerogel fire-proof and heat-insulating paint is applied to insulate thermal runaway or thermal dissipation of battery module in electric automobiles;
the aerogel fire-proof and heat-insulating paint is applied to reduce severe deformation of iron plates of a fire-proof door or a roll-up door due to high thermal difference when the fire-proof door or the roll-up door is burned by a high temperature flame from 850 to 1200° C. for more 3 hours.

12. An aerogel fire-proof and heat-insulating paint, characterized by being formed of aerogel particles having various sizes and hydrophobicity/hydrophilicity in addition with a high-temperature-resistant glue solution, wherein the aerogel particles having various sizes and hydrophobicity/hydrophilicity comprises a dried aerogel particle, and the high-temperature-resistant glue solution comprises a pure inorganic glue material, an organic glue material, an inorganic glue material blending an organic material or any combination thereof.

13. The aerogel fire-proof and heat-insulating paint according to claim 12, wherein the dried aerogel particle is made by a method comprising steps of:
a mixed hydrolysis step: adding a siloxane precursor to an ethanol water solution so as to form a mixed solution, and adding an acid catalyst to the mixed solution so that a hydrolysis reaction is performed, wherein the siloxane precursor comprises hydrophobic-modified siloxane compound having alkyl groups with chain of variable length, siloxane compound or a combination thereof;
a condensation and dispersion step: adding a alkali catalyst solution to the mixed solution to perform a condensation reaction so as to obtain a condensation solution, and adding a dispersing solution to the condensation solution, and then using an emulsifier or a homogenizer for rapid dispersion of the condensation solution so that hydrolyzed siloxane compound mixture in the condensation solution is condensed into sol droplets, wherein the sol droplets are suspended in the dispersing solution, and then the sol droplets are condensed into an aerogel wet gel particle having a steady hydrophobic shell and homogeneously dispersed in the dispersing solution; and
an atmospheric drying step: at atmospheric pressure and a drying temperature, filtering the dispersing solution by using a filtration machine so as to obtain the aerogel wet gel particle, and then providing an air flow having the drying temperature at atmospheric pressure to rapidly evaporate remaining solvent from the aerogel wet gel particle so as to obtain a dried aerogel particle, wherein the drying temperature ranges from 60 to 180° C.

14. The aerogel fire-proof and heat-insulating paint according to claim 13, wherein the siloxane compound comprises tetramethoxysilane (TMOS), tetraethoxysilane (TEOS) or the combination thereof; the hydrophobic-modified siloxane compound comprises methyltrimethoxysilane, propyltrimethoxysilane, hexyltrimethoxysilane, octyltrimethoxysilane, hexamethyldisilazane or a combination of any two or more thereof, wherein in the siloxane precursor, a molar ratio of the siloxane compound to the hydrophobic-modified siloxane compound ranges from 0:100 to 95:5.

15. The aerogel fire-proof and heat-insulating paint according to claim 13, wherein the atmospheric drying step comprises:
a solvent vaporizing step: at an azeotropic vaporizing temperature, rapidly azeotropically vaporizing the solvent in the structure of the aerogel wet gel particle to distilling dry the solvent so as to obtain a dried aerogel structure, wherein the azeotropic vaporizing temperature ranges from 60 to 100° C.; and
a solvent bumping step: adjusting the drying temperature to a bumping temperature so that the solvent in the dried aerogel structure bumps rapidly with water molecules to produce a positive vapor pressure so that dried condensation of the dried aerogel structure is suppressed and a large amount of micropores in the dried aerogel structure is produced, and obtaining the dried aerogel particle having higher thermal insulation property, wherein the bumping temperature ranges from 100 to 180° C.

16. The aerogel fire-proof and heat-insulating paint according to claim 12, wherein the inorganic gelling solution comprises water glass, silica oligomolecules, aluminum hydroxide molecules, inorganic silicone resin, copper oxide-phosphoric acid mixture, silicate molecules, inorganic silicon polymer, phosphoric acid-silicate mixture, magnesium oxide-silica-borax mixture, hollow silicon dioxide balls or a combination of any two or more thereof;
wherein the organic gelling solution comprises high-temperature resistant silica gel, silicone-modified polyurethane, silicone-modified acrylic resin, silicone-modified polyvinyl alcohol, and organic thermosetting resin selected from epoxy resin, organic high-temperature resistant silicone resin, and hollow organic resin, hollow organic foam balls, silicone modified epoxy resin, or any combination thereof.

17. The aerogel fire-proof and heat-insulating paint according to claim 13, wherein the inorganic glue material blending an organic material comprises 45 to 97 v/v % inorganic glue material and 3 to 55 v/v % organic glue material.

18. The aerogel fire-proof and heat-insulating paint according to claim 12, made by a method comprising steps of:
a high-temperature-resistant glue mixing step: preparing a high-temperature-resistant glue solution and gently stirring the high-temperature-resistant glue solution, and adding the dried aerogel particle to the high-temperature-resistant glue solution; dispersing and impregnating the dried aerogel particle in the high-temperature-resistant glue solution with gentle stirring, wherein the high-temperature-resistant glue solution is able to resist a high temperature of at least 1200° C.; and
a homogenizing and dispersing step: homogenizing the high-temperature-resistant glue solution dispersing and impregnating the dried aerogel particle by using a stirring machine so as to form an aerogel fire-proof and heat-insulating paint, wherein the aerogel fire-proof and heat-insulating paint presents functionalities including smoke-free, toxic-free, high fireproof and high thermal insulation.

19. The aerogel fire-proof and heat-insulating paint according to claim 18, wherein the homogenizing and dispersing step further comprises: adding a wetting agent, a de-bubbling agent and a dispersing agent to the high-temperature-resistant glue solution dispersing and impregnating the dried aerogel particle to completely and homogeneously disperse the dried aerogel particle in the high-temperature-resistant glue solution.

20. The aerogel fire-proof and heat-insulating paint according to claim 12, wherein the dried aerogel particle inside the aerogel fire-proof and heat-insulating paint comprises a porous structure, wherein the porosity of the dried aerogel particle ranges from 75.0 to 95.0%, the density thereof ranges from 0.06 to 0.12 g/cm³, the thermal conductive coefficient thereof ranges from 0.016 to 0.025 W/mK, the dielectric constant thereof ranges from 1.30 to 1.85, the flame resistance thereof is from UL94-V0 to UL94-5VA.
